(19) United States
(12) Patent Application Publication
(10) Pub. No.: US 2018/0343185 A1
(43) Pub. Date: Nov. 29, 2018

(54) Setting Thresholds for Monitoring Network Anomalies Within A Graphical User Interface

(71) Applicant: Brocade Communications Systems, Inc., San Jose, CA (US)

(72) Inventors: Santhoshkumar Kolathur, Milpitas, CA (US); Aruna Sangli, San Jose, CA (US)

(21) Appl. No.: 15/605,710

(22) Filed: May 25, 2017

(51) Int. Cl. H04L 12/26; H04L 12/24

(52) U.S. Cl. CPC H04L 43/16; H04L 41/0681; H04L 41/22

(57) ABSTRACT

A management station according to the present disclosure sets thresholds for monitoring network anomalies within a network. The management station receives a user input for a graphical display, where the graphical display includes a performance graph within a window that displays data for one or more network characteristics within the network. The user input triggers creation of a threshold to monitoring the one or more network characteristics associated with the performance graph. After triggering the creation of the threshold, the management station automatically creates the threshold based on the user input and context of the performance graph. The management station then monitors the display data on the performance graph with the created threshold.

### BACKGROUND OF THE DISCLOSURE

### 1. Field of the Disclosure

The present disclosure relates generally to network device management and more particularly to setting thresholds within a graphical user interface for network anomaly detection.

### 2. Description of the Related Art

Network management software provides network administrators a way of tracking the various characteristics of network devices, such as switches, routers, and the like, in a data communication network. Examples of these characteristics include, but are not limited to, CPU utilization, memory utilization, unused ports, and number of events on devices in a network. Network management software, such as Brocade® Network Advisor by Brocade Communication Systems, Inc., generally has a graphic user interface (GUI) (e.g., an analytics dashboard) that allows a network administrator to monitor numerous types of network characteristics in a single display. In particular, the network management software allows network administrators to create rules and/or policies to monitor and provide notifications for various network characteristics. Unfortunately, setting up monitoring rules and/or policies using the network management software typically involve having a network administrator perform a complex and multi-step process.

The network management software typically stores and implements monitoring rules and/or policies to monitor network anomalies for a variety of network characteristics, such as data traffic, flow, fabric, and network device performance. To configure specific monitoring rules and/or polices onto a network device, network administrators generally set thresholds for the network characteristics. The thresholds are included within monitoring rules and/or policies that monitor network characteristics and trigger actions to take when corresponding network characteristics exceed the thresholds. Network administrators generally have to manually configure thresholds by following a set of procedures that are often tedious and cumbersome. Also, at the time of setting the thresholds, network administrators may not have immediate access to information to determine what thresholds to use. As such, improving technology that efficiently sets thresholds for monitoring network anomalies remains valuable in properly managing network performance.

### SUMMARY OF THE DISCLOSURE

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the invention or to delineate the scope of the invention. Its sole purpose is to present some concepts in a simplified form as a prelude to the more detailed description that is discussed later.

According to the embodiments of the present disclosure, a management station provides a threshold input option that reduces the number of user inputs a network administrator uses to set a threshold to monitor for network anomalies. Rather than implement a series of complex and tedious set of instructions to set thresholds, the threshold input option reduces the number of user inputs to a just a few user inputs when setting a threshold to monitor network characteristics. While a network administrator is viewing network characteristics within an opened monitoring window, the network administrator provides just a few user inputs (e.g., right mouse click) to set a threshold for the viewed network characteristic. The threshold input option allows the network administrator to set temporary thresholds that remain active as long as the monitoring window remains open and/or set permanent thresholds that continue monitoring the thresholds even after the network administrator closes and/or minimizes the monitoring window. The threshold input option automatically constructs the monitoring rule and/or policy that includes the threshold by deducing the measured network characteristics, data sizes, time base, and/or network scope, applying the monitoring rule and/or policy to the switching device, and automatically activating the monitoring rule and/or policy. After receiving the user input to set a threshold using the threshold input option, the threshold input option generates one or more visual indications within the monitoring window when the monitored characteristics (e.g., flows and/or data traffic) cross the defined threshold.

### BRIEF DESCRIPTION OF THE FIGURES

The present disclosure has other advantages and features which will be more readily apparent from the following detailed description of the disclosure and the appended claims, when taken in conjunction with the accompanying drawings, in which:

FIG. 1 is a diagram illustrating a local area network (LAN) and wide area network (WAN) where embodiments of the present disclosure may operate herewith.

FIG. 2 is a schematic diagram of an embodiment of a switching device that may be utilized in an Ethernet network.

FIG. 3 is a schematic diagram of an embodiment of a storage area network (SAN) 300 where embodiments of the present disclosure may operate herewith.

FIG. 4 is a schematic diagram of an embodiment of a switching device that may be utilized in a SAN.

FIG. 5 illustrates a block diagram of a management station that may be utilized in accordance with embodiments of the present disclosure.

FIG. 6 illustrates a monitoring window within a GUI that sets thresholds using a threshold input option.

FIG. 7 illustrates another embodiment of a monitoring window that sets thresholds using the threshold input option

FIG. 8 illustrates another embodiment of a monitoring window that sets thresholds using the threshold input option.

FIG. 9 is a flow chart of an embodiment of method used to create and activate a threshold using the threshold input option.

### DETAILED DESCRIPTION OF THE PREFERRED EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques described below, including the exemplary designs and implementations illustrated and described herein, but may be modified within the scope of the appended claims along with their full scope of equivalents.

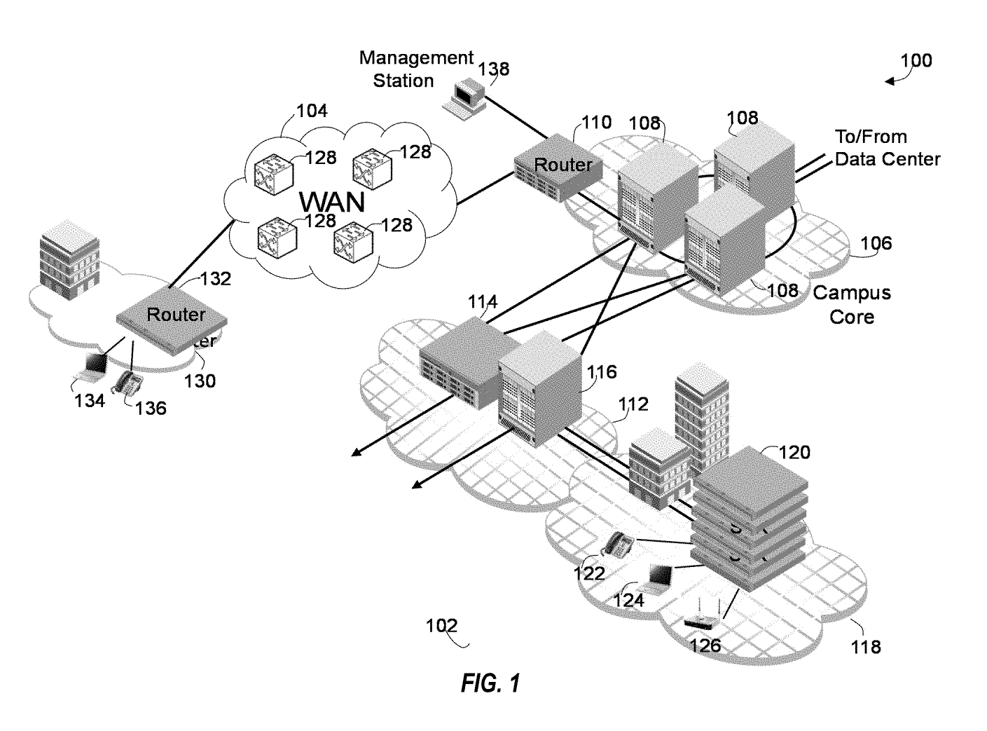

FIG. 1 is a schematic diagram of an embodiment of an Ethernet network 100 where embodiments of the present disclosure may operate herewith. Referring to FIG. 1, an Ethernet network 100 is shown where a LAN 102 is interconnected to a remote campus 130 via WAN 104. The campus core 106 includes a plurality of interconnected core switches 108. The core switches 108 are connected to a data center (not shown). A router no is connected to the core switches and the WAN 104. The LAN 102 is connected to the WAN 104 via router no. The core switches 108 are connected to switches 114 and 116 of an aggregation campus 112. The aggregation campus switches 114 and 116 are connected to switches 120 of large network 118 and provide data communication services to the large network's telephone 122, computer 124, and wireless access 126 devices. The aggregation network switches 114 and 116 may also be connected to additional campuses (not shown) in order to provide additional data communication services. The WAN 104 is comprised of a plurality of interconnected Ethernet switches 128 and other networking devices (not shown). WAN 104 is connected to remote campus 130 via a router 132. Router 132 provides data communication services to computers 134 and telephone devices 136. It is understood that this is an exemplary network and numerous other network topologies can be monitored according to the present invention.

As shown in FIG. 1, a management station 138 is connected to router no of the campus core 106. As will be appreciated by one having ordinary skill in the art, the management station 138 allows a network administrator to monitor the data traffic, port utilization, and various other networking characteristics of each switching device in the Ethernet network 100. Stated another way, the management station 138 is configured to deliver visibility and insight access to Ethernet network 100, such as detecting network anomalies. Unless otherwise specified within the disclosure, the term “management station” may be interchanged with and considered synonymous throughout this disclosure with the term “network advisor.” Moreover, unless otherwise specified within the disclosure, the term “network characteristic” may be interchanged with and considered synonymous throughout this disclosure with the term “network metric.”

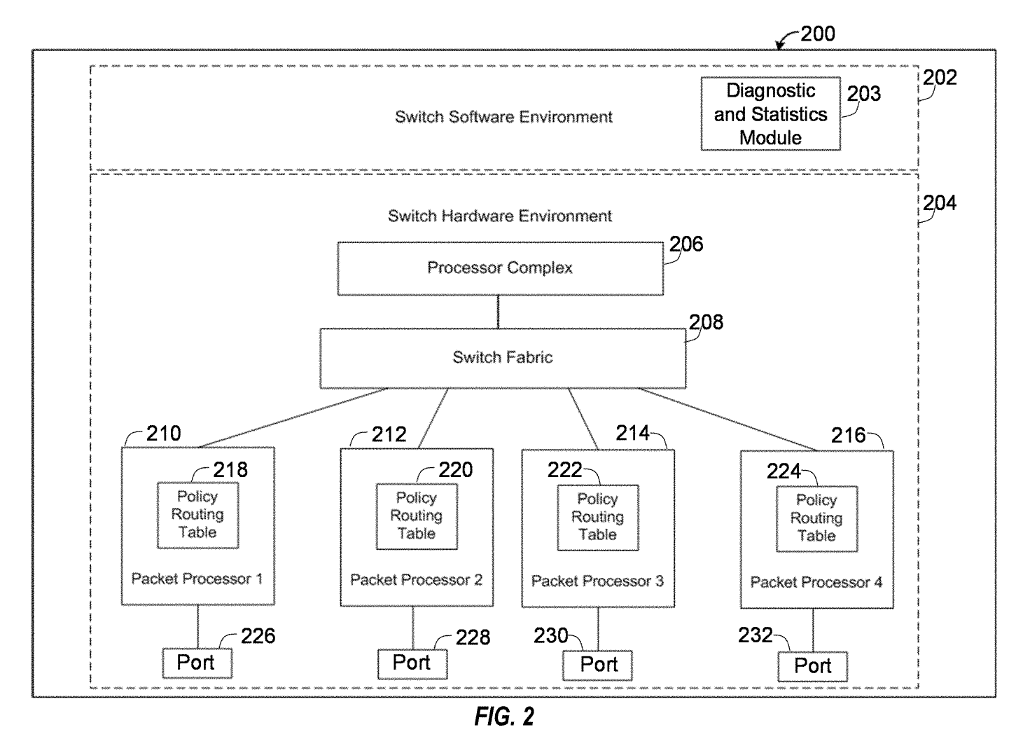

FIG. 2 is a schematic diagram of an embodiment of a switching device 200 (e.g., an Ethernet switch) that may be utilized in an Ethernet network, such as Ethernet network 100 shown in FIG. 1. The switching device 200 comprises a switch software environment 202 and switch hardware environment 204. The switch software environment 202 includes a diagnostics and statistics module 203 to allow the network management software access to the various statistical counters in the switching device 200, such as receive and transmit rate counters for each port 226, 228, 230, 232. In one embodiment, the diagnostics and statistic module 203 includes a monitoring and alerting policy suite (MAPS) module that stores and implements rules and/or policies related to monitoring network characteristics, such as data traffic and/or flows. The MAPS module monitors the network characteristics at the switching device 200 and compares the switching device 200 to one or more thresholds. Based on the comparison, the MAPS module may generate and transmit a notification of possible performance issues back to a management station to alert a network administrator. In preferred embodiments, the MAPS module includes elements of the switch fabrics 208 and/or processor complex 206 to perform frame counting and software elements to program the counters and to read the counters and to perform data manipulation.

FIG. 2 illustrates that the switch hardware environment 204 has a processor complex 206 that provides the overall management and control of the switching device 200. The processor complex 206 is connected to a switch fabric 208, which provides the basic switching operations for the switching device 200. The switch fabric 208 is connected to a plurality of packet processors 210, 212, 214, and 216. Each packet processor 210, 212, 214, and 216 has its own respective policy routing table 218, 220, 222, and 224 to provide conventional packet analysis and routing. Each packet processor 210, 212, 214, and 216 is connected to its own respective port or ports 226, 228, 230, and 232. When the switching device 200 is implemented in a network, such as Ethernet network 100, the data value of each port 226, 228, 230, and 230 may be monitored and analyzed using a network management software on a management station, such as management station 138 shown in FIG. 1. Again, it is understood that this is an exemplary switching device architecture and numerous other architectures can be used according to the present invention.

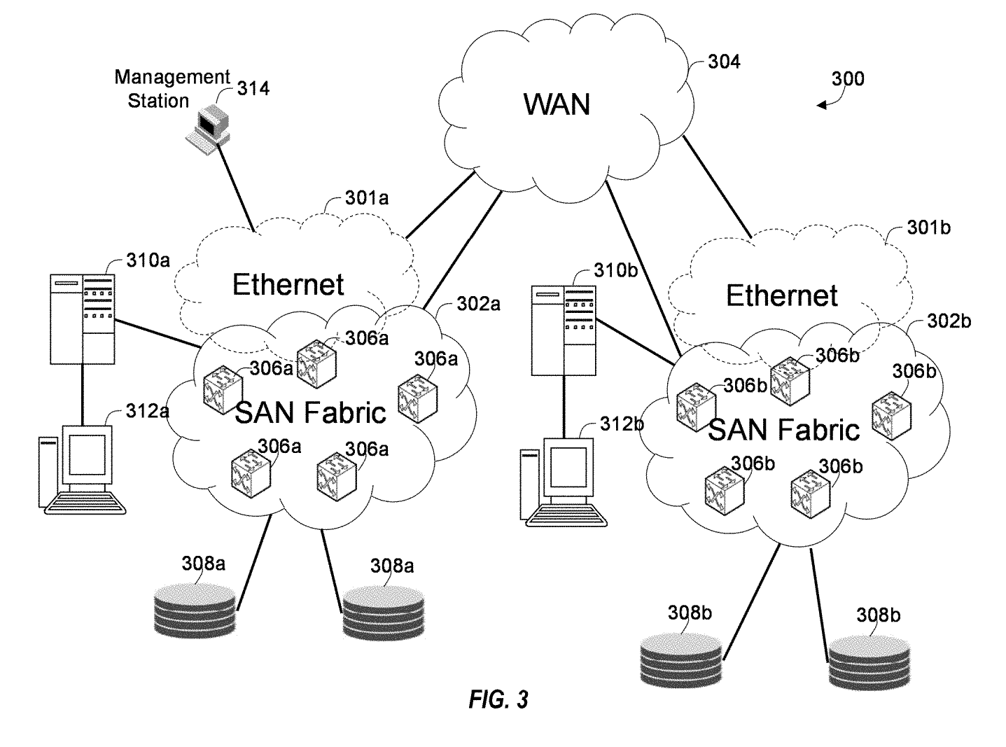

FIG. 3 is a schematic diagram of an embodiment of a SAN 300 where embodiments of the present disclosure may operate herewith. The SAN 300 may utilize the Fibre Channel (FC) protocol to transmit and receive data. As shown, a plurality of FC SAN fabrics 302a and 302b are interconnected via WAN 304. The SAN fabrics 302a and 302b are comprised of a plurality of FC switches 306a and 306b, respectively. SAN fabric 302a is connected to a plurality of storage devices 308a. Likewise, SAN fabric 302b is connected to a plurality of storage devices 308b. Each SAN fabric 302a and 302b connect their respective storage devices 308a and 308b to application servers 310a and 310b, which are in turn are connected to computers 312a and 312b. This configuration allows for computer 312a to access storage devices 308b and for computer 312b to access storage devices 308a. As above, FIG. 3 is an exemplary FC SAN architecture and numerous other FC architectures can be managed according to the present invention.

As shown in FIG. 3, a management station 314 is connected to Ethernet LAN 301a, which is connected directly to SAN network 302a and indirectly to Ethernet LAN 301b via WAN 304. Ethernet LANs 301a and 301b are connected to the Ethernet management ports of the switches 306a and 306b to provide a management network for the switches 306a and 306b. As will be appreciated by one having ordinary skill in the art, the management station 314 allows a network administrator to monitor the data traffic, port utilization, and various other networking characteristics using network management software such that any data congestion may be alleviated. The management station 314 may be configured to perform similar operations as described for management station 138 shown in FIG. 1.

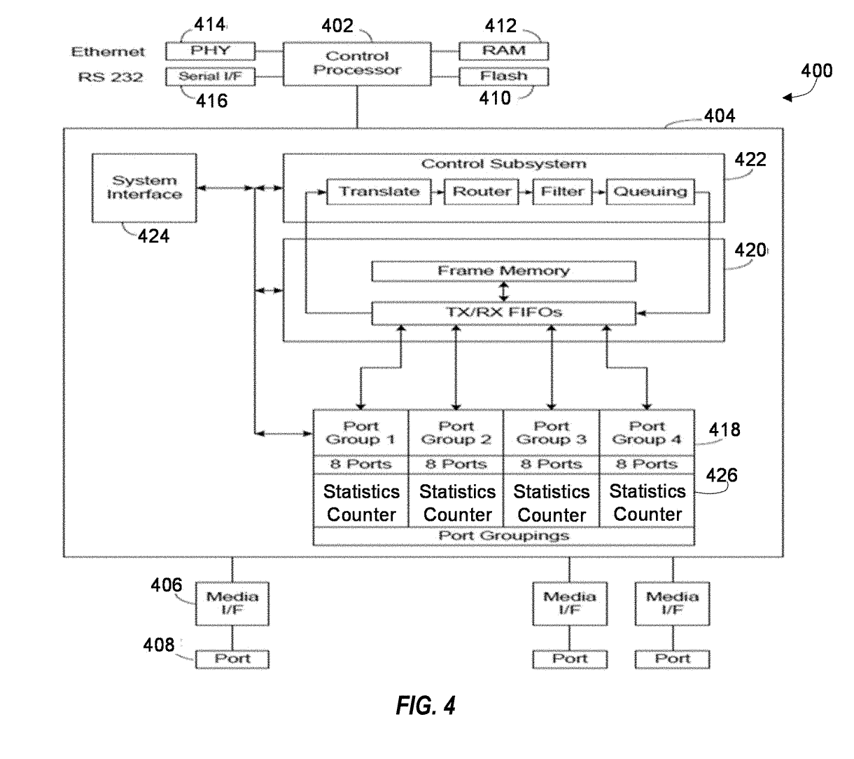

FIG. 4 is a schematic diagram of an embodiment of a switching device 400 (e.g., a FC switch) that may be utilized in a SAN, such as SAN 300 shown in FIG. 3. FIG. 4 illustrates that a control processor 402 is connected to a switch ASIC 404. The switch ASIC 404 is connected to media interfaces 406 which are connected to ports 408. Generally, the control processor 402 configures the switch ASIC 404 and handles higher level switch operations, such as the name server, the redirection requests, and the like. The switch ASIC 404 handles the general high speed inline or in-band operations, such as switching, routing, and frame translation. The control processor 402 is connected to flash memory 410 to hold the software, to RAM 412 for working memory and to an Ethernet PHY 414 used for management connection and serial interface 416 for out-of-band management.

The switch ASIC 402 has four basic modules, port groups 418, a frame data storage system 420, a control subsystem 422 and a system interface 424. Generally, frames are received from a media interface 406 and provided to the frame data storage system 420. Further, frames are received from the frame data storage system 420 and provided to the media interface 406 for transmission out a port 408. The port groups 418 perform the lowest level of packet transmission and reception, and include a statistics counter module 426 to allow diagnostic and statistics software to access the various statistical counters of the switching device 400, such as receive and transmit rate counters for each port. In one embodiment, the diagnostic and statistics software includes a MAPS module that is similar to the MAPS module included in FIG. 2's diagnostics and statistic module 203. Recall that the MAPS module stores and implements rules and/or policies related to monitoring network characteristics, such as data traffic and/or flows. The MAPS module may use the statistics counter module 416 to obtain data regarding network characteristics and compare this data to one or more thresholds. In preferred embodiments, the MAPS module includes elements of the switch ASIC 404 to do frame counting and software elements to program the counters and to read the counters and to perform data manipulation.

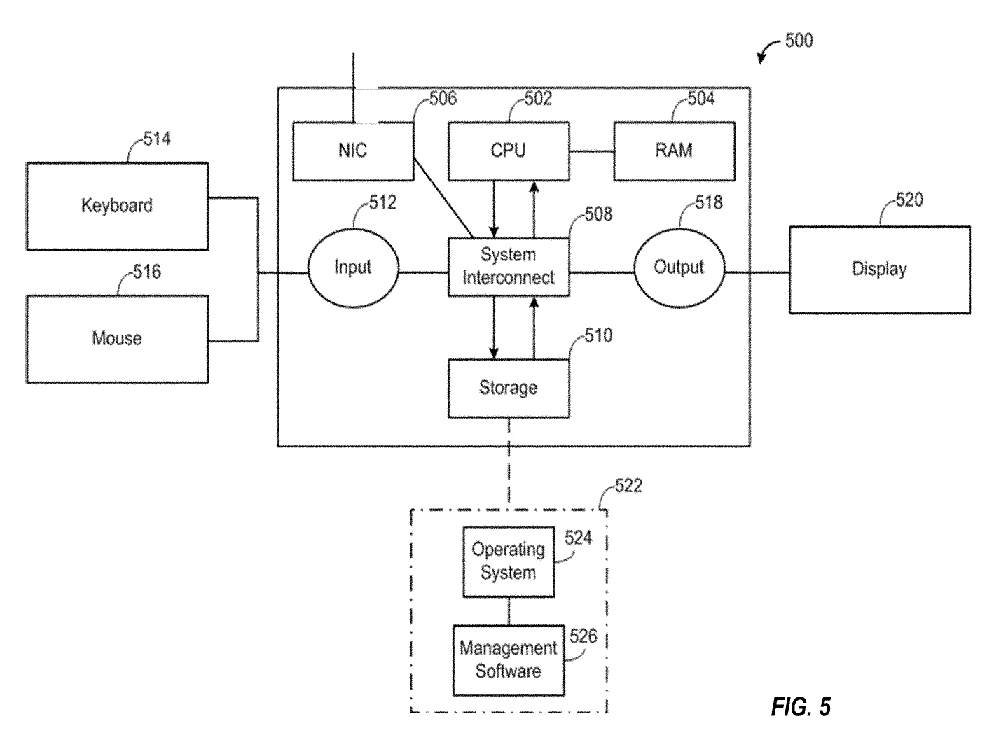

FIG. 5 illustrates a block diagram of a management station 500, similar to management stations 138 and 314, that may be utilized in accordance with the present invention. As shown, the management station 500 is comprised of a central processing unit (CPU) 502, random access memory (RAM) 504, network interface card (NIC) 506, system interconnect 508, storage component 510, input component 512, and output component 518 which are all interconnected via the system interconnect 508. The input component 512 may be connected to an input device, such as a keyboard 514 and mouse 516. The output component 518 is connected to a display device 520, such as an LCD monitor. Storage component 510, such as a non-transitory storage device, stores software 522, which typically includes an operating system 524 and network management software 526. The NIC 506 allows the management station 500 to communicate with a network. As understood by those skilled in the art, network management software 526 is typically designed to allow a network administrator to quickly and efficiently monitor and manage a large network via a GUI, such as an analytic dashboard. The network management software 526 could be, for example, Brocade® Network Advisor by Brocade Communication Systems, Inc. Once booted, the management station 500 loads the operating system 524 from the storage 510 into the RAM 504. From the operating system 524a user may run the network management software 526, which is then also loaded into the RAM 504. The interface of the network management software 526 is then displayed on the display 520 via the output component 518. The management software 526 allows a user to monitor numerous network characteristics, such as the number events on the network, number of unused ports of network devices, memory utilization of network devices, bandwidth utilization of network devices, and CPU utilization of network devices. It is understood that this is an exemplary computer system architecture and numerous other computer architectures can be used according to the present invention.

In one embodiment, the network management software 526 is configured to manage one or more policies that monitor and detect anomalies or performance based issues within a network. For instance, the network management software 526 may be able configure, edit, delete, activate, and/or deactivate monitoring rules and/or policies for a network device (e.g., switching device 200 and 400). Within a network, a single network device may be configured with multiple policies set by the network management software 526. For example, the network management software 526 may utilize a policy for everyday use and another policy for when the network administrator is running backups or performing switch maintenance. Additionally or alternatively, the network management software 526 may be able to distribute policies from one network device to another network device. For purposes of this disclosure and unless otherwise specified, the term “policy” refers to one or more monitoring rules that include one or more thresholds. A policy may also include actions to take when measured network characteristics trigger one or more thresholds. When a network administrator via the network management software 526 enables a policy, the policy becomes active and the monitoring rules in the policy take effect.

In one embodiment, a monitoring rule is configured to associate a condition with actions that need to be triggered when the condition is met. If the specified condition is met (e.g., evaluated to be true), the monitoring rule is triggered. The condition may include a time base parameter and a threshold. The time base represents the time interval between two samples to compare, and the threshold represents a value at which potential problems might occur. As an example, the network management software 526 can configure a monitoring rule onto a network device that includes the following: “for all F_ports, if the change in the cyclic redundancy check (CRC) counter in the last minute is greater than 10, then fence the port and issue a switch message log (e.g., RAS Log) message.” The threshold in this example is 10, the time base parameter is “the last minute” and the action is “fence the port and issue a switch message log message.” Another example of a threshold includes configuring a port threshold where a network administrator can select a specific value at which an action is triggered because of too many threshold violations.

The network management software 526 is configured to provide a threshold input option that defines a threshold that a network administrator may use to monitor network characteristics. The threshold input option reduces the number of user inputs a network administrator may provide to set a threshold. For instance, without the threshold input option, a network administrator generally performs a pre-determined sequence of user inputs using the network management software 526 to set a threshold. The series of user inputs can include, but are not limited to navigating to the applicable menu options and/or tabs to create within a GUI, performing numerous clicks (e.g., mouse right-clicks) to select certain options, manually entering monitoring rule and policy information, and/or manually entering threshold values. According to an embodiment with the threshold input option, the network management software 526 reduces the number of user inputs to just a few user inputs (e.g., just a few mouse clicks) when setting a threshold to monitor network characteristics.

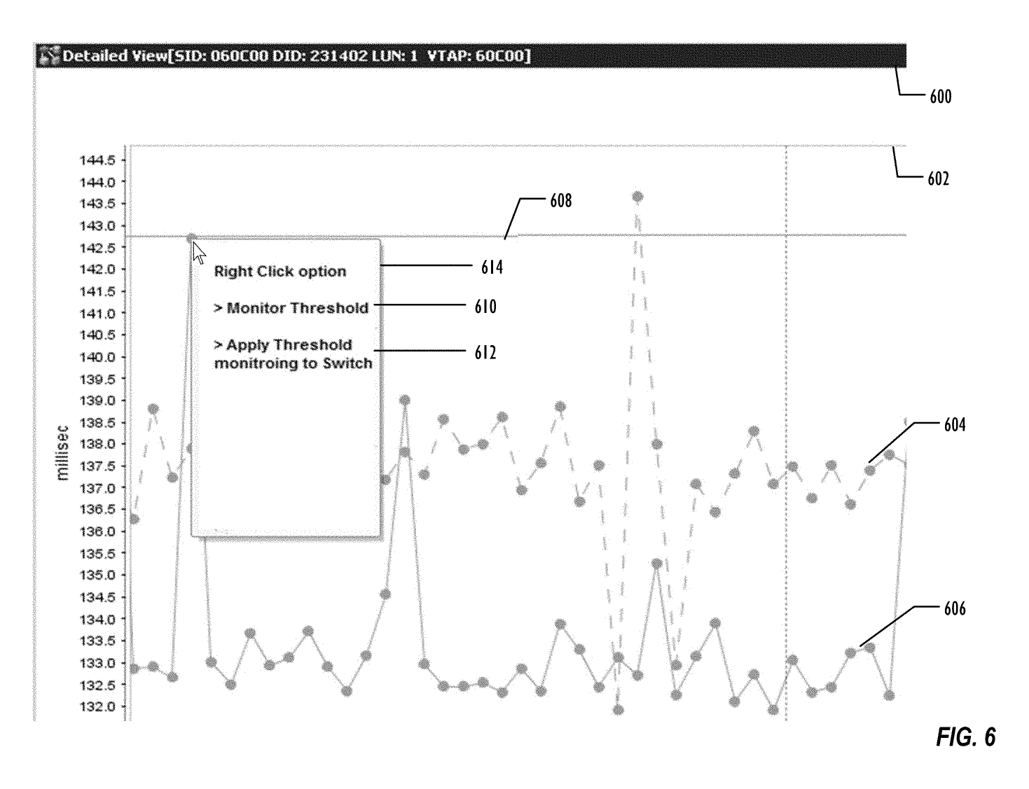

The threshold input option is configured to set one or more thresholds while monitoring network characteristics within an opened monitoring window. By doing so, the network administrator can determine and set more accurate threshold values when viewing data displayed on active performance graphs. In one embodiment, the threshold input option sets thresholds that remain active as long as the monitoring window remains open. In this embodiment, the network management software 526 deletes or deactivates the threshold when a network administrator closes or minimizes the monitoring window used to create the threshold with the threshold input option. Additionally or alternatively, the threshold input option includes features that allow for continued monitoring of the threshold for a longer duration than when a monitoring window is open and/or being viewed. For example, in response to the network management software 526 receiving user input to set a threshold using the threshold input option, the network management software 526 is able to automatically configure the threshold onto a monitored network device (e.g., switching device 200 and 400). Based on contextual information being displayed, the threshold input option automatically constructs the monitoring rule and/or policy that includes the threshold by deducing the measured network characteristics, data sizes, time base, and/or network scope, applying the monitoring rule and/or policy to the switching device, and automatically activating the monitoring rule and/or policy. After receiving user input to set a threshold using the threshold input option, the network management software 526 generates one or more visual indications within the monitoring window when the monitored characteristics (e.g., flows and/or data traffic) cross the defined threshold. Creating and activating thresholds with the threshold input option are discussed in further detail in FIGS. 6-8.

The network management software 526 can also be configured to remove thresholds created with the threshold input option. In other words, the network management software 526 may be configured to delete or deactivate the monitoring rules and/or policies set with the threshold input option. In one embodiment, the network management software 526 automatically deletes or deactivates the thresholds created with the threshold input option. For example, the network management software 526 may automatically delete or deactivate the thresholds based on an occurrence of an event, such as closing the monitoring window, minimizing the monitoring window, and/or expiration of a designated time duration. Regarding the expiration of a designated time duration, once the network management software 526 creates a threshold with the threshold input option, the network management software 526 may automatically start a counter that tracks the elapsed time since creating the threshold. Once the elapsed time exceeds the designated time duration (e.g., about ten minutes), the network management software 526 deletes or deactivates the threshold. Additionally or alternatively, the network management software 526 allows a network administrator to manually delete or deactivate the thresholds created with the threshold input option. For example, the network management software 526 could use a specific naming convention to allow easier groupings of the thresholds created using interface click option. By doing so, a network administrator is able to delete or deactivate multiple thresholds simultaneously by instructing the network management software 526 to delete or deactivate one or more groupings.

Although FIGS. 1-5 illustrate specific embodiments of a network, switching device, and management stations, the disclosure is not limited to the specific embodiments illustrated in FIGS. 1-5. For example, FIGS. 1 and 3 illustrate that embodiments of the present disclosure may operation on Ethernet network 100 and SAN 300; however, other embodiments may operate in other types of networks, such as radio-based networks (e.g., wireless fidelity (Wi-Fi®), Bluetooth® network, and Zigbee® networks) and network on chips (NoC). Further, while FIGS. 1-5 illustrate that the switching devices 200 and 400 and management station 500 as separate and independent devices, other embodiments could have one or more of the switching devices and/or management station as subsystems or components located on a single device, such as an integrated circuit. The use and discussion of FIGS. 1-5 are only examples to facilitate ease of description and explanation.

FIG. 6 illustrates a monitoring window 600 within a GUI (e.g., analytic dashboard) that sets thresholds using a network management software's threshold input option. As shown in FIG. 6, the monitoring window 600 includes data for flows 604 and 606 that traverse a specific switching device. When a network administrator is viewing the data for the specific switching device, the network administrator may decide to set a threshold for the flows 604 and 606. To do this, the network administrator provides one or more user inputs at one or more locations on the window 600 and/or performance graph 602 to bring about one or more options to set a threshold. Examples of user inputs for the threshold input options include, but are not limited to, a right-click with a mouse, double click with a mouse, click and hold with a mouse, tap using multiple fingers on a touch screen, tap and hold on a touch screen, and/or double tapping using a finger and/or touch point device.

As shown in FIG. 6, the monitoring window 600 (e.g., widget) is part of a GUI (e.g., analytic dashboard) that displays input/output (I/O) performance metrics (e.g., I/O sizes and response times) for one or more network devices associated with one or more flows in a network. For example, the monitoring window 600 and GUI are part of network management software for an analytics system that monitors a variety of latency metrics. In one embodiment, the analytics systems monitors and accumulates the I/O performance metrics using mirror command frames, which is described in more detail in U.S. patent application Ser. No. 15/273,968 entitled “High Granularity Link Oversubscription Detection,” filed Sep. 23, 2016, which is hereby incorporated by reference as if reproduced in its entirety. Specifically, Table 1 shown below illustrates the time values for the relevant operation, which are described in more detail in U.S. patent application Ser. No. 15/273,968. The maximum time values represent the high values in the latest indicated time period. The average time values are the average of the values in the latest indicated time period.

TABLE 1

| | | Max | | | Average | | |
|---|---|---|---|---|---|---|---|
| | | 10 | 5 | | 10 | 5 | |
| IO Latency Metrics | IO Size | sec | min | All | sec | min | All |

| | |
|---|---|
| Read Completion | <8K |
| | 8K-<64K |
| | 64K-<512K |
| | >=512K |
| Read First Response | |
| Write Completion | |
| Write Xfer Ready | |
| Fabric Latency | All |
| Other command | All |
| completion | |

The threshold input options provide a network administrator a variety of options on how to set the threshold for one or more I/O performance metrics. As an example, FIG. 6 illustrates that the threshold input option can be activated with a right-click user input that displays a right click window 614. The right click window 614 provides the network administrator two options on how to set the threshold for displayed I/O performance metric. The “monitor threshold” option 610 allows the network administrator to temporarily create and activate a threshold to monitor the flows, for example, as long as the monitoring window 600 remains open and/or for a pre-determined duration of time. The “Apply Threshold Monitoring to Switch” option 612 creates and activates a threshold for a longer duration than “the monitor threshold” option 610 and/or can remain active until a network administrator provides instructions to manually delete or deactivate the threshold. Once the network administrator provides user input to select one of the options, the threshold input option creates a threshold based on the context conveyed in the monitoring window 600 and/or performance graph 602. Examples of context conveyed in the monitoring window 600 and/or performance graph 602 include, but are not limited to, the location of the right click, the data being shown in the performance graph 602, and other network characteristic-based information associated with the monitoring window 600 and/or performance graph 602. Additionally, user preferences set within the network management software can be used to create aspects of the threshold.

In one embodiment, the threshold input option automatically sets a numerical value for a threshold of a monitoring rule and/or policy based on the location of a user input. Continuing to use FIG. 6 as an example, the network administrator performs a right-click as a user input at the 142.7 millisecond value corresponding to a specific I/O performance metric. Examples of the I/O performance metric the performance graph 602 could correspond to include, but are not limited to, a read complete time, a write complete time, a read first response time, a write response time, a fabric latency I/O status time, and/or some other command latency metric. Based on the location of the right-click, the threshold input option sets the threshold value to 142.7 milliseconds.

The threshold input option may also automatically determine the logical operator (e.g., “less than,” “less than or equal to,” “greater than,” “greater than or equal to,” or “equal to”) based on the data shown in the performance graph 602, the specific I/O performance metric being displayed, and/or user preferences set within the network management software. Using FIG. 6 as an example, majority of the data for flows 604 and 606 are located below the threshold value of 142.7 milliseconds and correspond to some type of latency metric. By utilizing the data values and/or the type of I/O performance metric, the threshold input option may determine that the logical operator should either be a “greater than” or a “greater than or equal to” logical operator. Additionally or alternatively, user preferences may also be set in such a manner that by default the logical operator excludes any “equal to” logical operation when using the threshold input option. By doing so, the threshold input option sets the logical operator to be the “greater than” instead of the “greater than or equal to.”

The threshold input option also uses contextual information associated with the monitoring window 600 and/or performance graph 602 to create other portions of the monitoring rule and/or policy besides setting the threshold. As shown in FIG. 6, the data within performance graph 602 includes data for flows 604 and 606 for a given switching device. Based on the type of data displayed on performance graph 602 and properties of the performance graph 602 (e.g., switch device information), the threshold input option may automatically determine the appropriate measured network characteristic, time base parameter, action, and/or network scope. For example, the threshold input option uses the contextual information to set the time base parameter and determine an action for the monitoring rule. As discussed above in FIG. 5, the time base parameter specifies a time interval between two samples to compare. The threshold input option sets the time base parameter using the same time interval set between the data points displayed in performance graph 602 and determines one or more triggered actions (e.g., generate an electronic mail (email) notification and create an entry in an internal event log) to take based on the type of measured data points being displayed in performance graph 602. Additionally or alternatively, the threshold input option may utilize user preferences to set the time base parameter and the triggered action. As an example, the user preferences may be configured such that the default time base is set to a specific time interval or may be set as not applicable (i.e., no time interval). The user preferences may also have the threshold input option generate a visual indication 608 on performance graph 602 as the triggered action when flows 604 or 606 exceed the defined threshold.

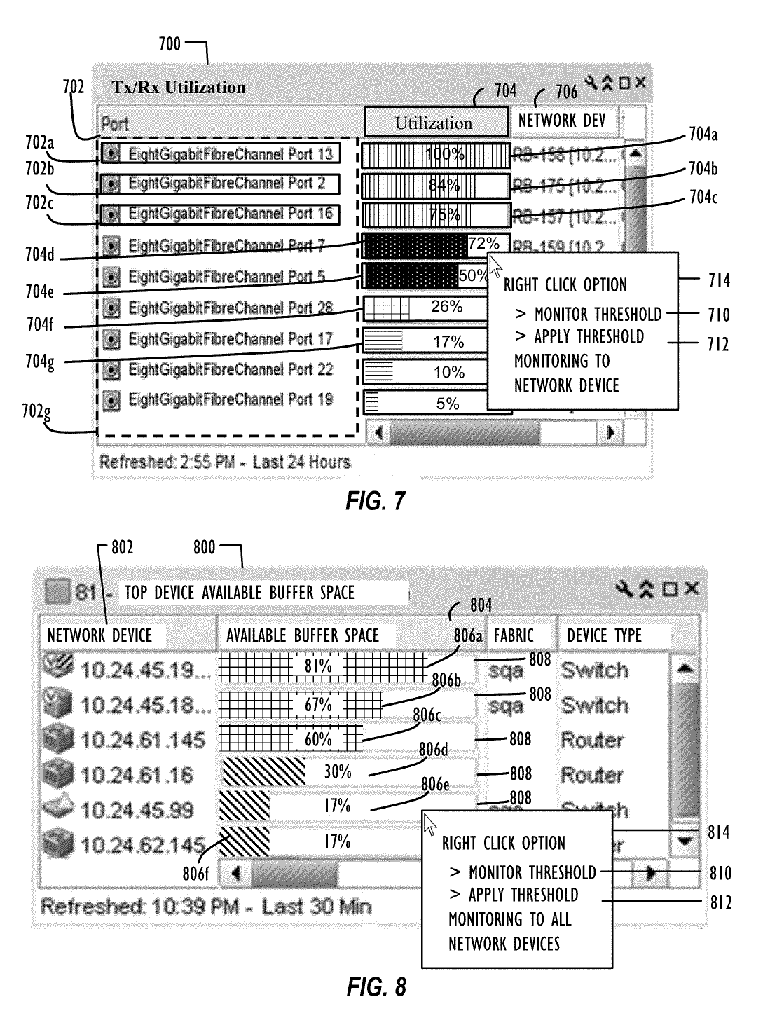

FIG. 7 illustrates another embodiment of a monitoring window 700 (e.g., widget) that sets thresholds using the threshold input option. As understood by those having skill in the art, network management software accumulates network performance metrics of a network by: (1) polling network devices 706 (e.g., switches) via application programming interface (API), command line interface (CLI) or simple network management protocol (SNMP); and/or (2) receiving warnings from network devices 706 (e.g., switch) on the network via API or SNMP. The network management software then displays the particular characteristics (e.g., bandwidth utilization) being tracked in a window, such as a widget, for the network administrator. As shown in FIG. 7, the plurality of ports 602 are sorted in descending order based on the port having the highest transmit (Tx) and/or receive (Rx) utilizations 704 of the plurality of ports 702. Consequently, the first port 702a in the arrangement has the highest TX utilization value 704a, the second port 702b in the arrangement has the second TX utilization value 704b, and the third port 702c in the arrangement has the third highest data transmit value 704c, The remaining ports are sorted based on their TX utilization value in the same manner as ports 702a through 704c.

In one embodiment, the bars for the Tx and/or Rx utilization 704 are color coded to indicate different utilization ranges. For example, the monitoring window 700 represents Tx and/or Rx utilization values 704a, 704b, and 704c as red bars to indicate utilization between 75% and 100%, Tx and/or Rx utilization values 704d and 704e as orange bars to indicate utilization between 50% and 75%, Tx and/or Rx utilization value 704f as a yellow bar to indicate utilization between utilization between 25% and 50%, and Tx and/or Rx utilization value 704g as a blue bar to indicate utilization between utilization between 0% and 25%. As would be understood by those of ordinary skill in the art, any color or other distinct visual identifier could be tied to any particular performance parameter value range. For example, the read bars could correspond to 90% to 100%, as opposed to 75% to 100%. Moreover, rather than using colors, patterns or other distinct visual identifier (e.g., a striped bar) could be used. Distinct visual identifier, in its broadest sense, is intended to be any visual identifier capable of representing a performance parameter value range (e.g., red for 75% to 100% utilization).

Similar to FIG. 6, FIG. 7 illustrates that the threshold input option can be activated with a right-click user input that displays a right click window 714. Recall that the right click window 714 provides a network administrator a variety of options on how to set the threshold. FIG. 7 depicts that the right click window 714 provides the network administrator two options on how to set the threshold for TX and/or RX utilization 704. The “monitor threshold” option 710 is similar to the “monitor threshold” option 610 by allowing the network administrator to temporarily create and activate a threshold to monitor the flows. The “Apply Threshold Monitoring to Network Device” option 712 is similar to the “Apply Threshold Monitoring to Switch” option 612 by creating and activating a threshold for a longer duration than the “monitor threshold” option 710 and/or can remain active until a network administrator provides instructions to manually delete or deactivate the threshold. Although FIG. 7 illustrates that the threshold input option is activated by a right-click user input, other user inputs can be used to activate the threshold input option. Additionally or alternatively, the threshold input option is not limited to providing two threshold setting options, but instead could include a single or more than two threshold setting options. For example, the threshold input option includes an additional option to apply threshold monitoring to all network devices 706 found within monitoring window 700.

As shown in FIG. 7, when a network administrator provides a right click user input associated with the Tx and/or Rx utilization value 704g to activate the threshold input option, the monitoring window 700 displays a right click window 714. When the network administrator selects either the monitor threshold option 710 or the “Apply Threshold to Monitoring Network Device” 712, the threshold input option sets a threshold value based on the Tx and/or Rx utilization value 704g, which would be 72%. The threshold input option also automatically determines that the logical operation would be “greater than” or “greater than or equal to” since the monitoring window corresponds to Tx and/or Rx utilization value 704g. In one embodiment, user preferences may also be set in such a manner that by default the logical operator excludes any “equal to” logical operation when using the threshold input option. By doing so, the threshold input option sets a threshold to monitor Tx and/or Rx utilization that exceeds 72% for ports corresponding to the network device 706 that has port 702g.

FIG. 8 illustrates another embodiment of a monitoring window 800 (e.g., widget) that sets thresholds using the threshold input option. The monitoring window 800 includes a network device column 802 and an available buffer space column 804. The available buffer space column 804 includes available buffer space bars 806a-806f that represent different available buffer space values for different network devices found in the network device column 802. Similar to monitoring window 700, a network management software is able to obtain network performance metrics by polling network devices within the network device column 802 and/or receive warnings from the network devices. As shown in FIG. 8, in response to the network administrator providing a right click user input, the monitoring window displays a right click window 814 that provides threshold input options. The “monitor threshold” option 810 is similar to the “monitor threshold” option 710 by allowing the network administrator to temporarily create and activate a threshold to monitor the flows. The “Apply Threshold Monitoring to all Network Devices” option 812 is similar to the “Apply Threshold Monitoring to Network Device” option 712 by creating and activating a threshold for a longer duration than the “monitor threshold” option 810 and/or can remain active until a network administrator provides instructions to manually delete or deactivate the threshold. In contrast to the “Apply Threshold Monitoring to Network Device” option 712, the “Apply Threshold Monitoring to all Network Devices” option 812 sets the threshold for all of the network devices listed network device column 802 in monitoring window 800.

FIG. 8 also illustrates that the right click user input occurs over the available buffer space bar 806e to activate the threshold input option. In one embodiment, by right clicking in the available buffer space column 804 corresponding to the available buffer space bar 806e, the threshold input option sets the threshold value based on the available buffer space bar's 806e value, which is shown to be at 17%. The threshold input option also automatically determines that the logical operation for the set threshold value. In this example, because network performance metric being monitored within the monitoring window 800 is available buffer space, the threshold input option determines to use a “less than” or “less than or equal to.” Similar to FIGS. 6 and 7, user preferences may also be set in such a manner that by default the logical operator excludes any “equal to” logical operation when using the threshold input option. By doing so, the threshold input option sets a threshold to monitor available buffer space that is less than 17% for each of the network devices listed in network device column 802.

In another embodiment, rather than using the available buffer space bar's 806e value to set thresholds, the threshold input option can use the actual location of the right click within the scale bars 808 to set the threshold value. Stated another way, the actual values of the available buffer space bar's 806a-806e are irrelevant and only the location of the actual right-click within the scale bar 808 is relevant for setting the threshold using the threshold input option. Using FIG. 8 as an example, a network administrator performs a right-click at a location on the scale bar 808. As discussed above, the previous embodiment sets the threshold to a value of 17% since the location of the right-click corresponds to the available buffer space bar 806e. In contrast, instead of having the threshold set to the available buffer space bar's 806e value (i.e., 17%), the threshold is set according to where the right click lands on the scale bar 808, which is greater than 17%. As shown in FIG. 8, the actual location of the right click (i.e., pointer location) on the scale bar 808 represents a value that is greater than available buffer space bar 806b and less than available buffer space bar 806a. Specifically, based on this location of the right click (i.e., pointer location) depicted in FIG. 8, the threshold set for the threshold input option is 78%.

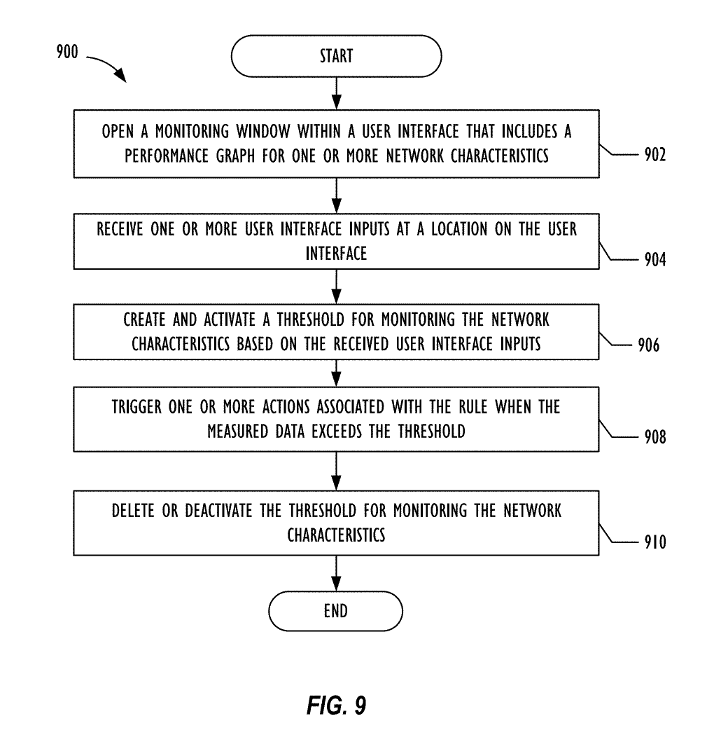

FIG. 9 is a flow chart of an embodiment of method 900 used to create and activate a threshold using the threshold input option. Using FIGS. 1-5 as an example, method 9 is implemented using the management station as described above (e.g., management station 138, 314, and 500). Method 900 is implemented to monitor one or more different network characteristics within a network on a temporary or permanent bases. For example, method 900 sets a threshold to temporarily monitor port health on a performance graph that the network administrator is currently viewing. Additionally or alternatively, method 900 may apply the threshold to a network device that remains active until a network administrator manually deactivates or deletes the threshold.

Method 900 starts at block 902 by the management station opening a monitoring window within a user interface that includes a performance graph for one or more network characteristics. In one embodiment, the performance graph may be graphically depicted as the performance graph 602 shown in FIG. 6. Method 900 then moves to block 904 and receives a user input at a location on the user interface. As discussed above, the user input may be a mouse right-click and/or other types of user inputs (e.g., hotkeys and keyboard shortcuts) from a network administrator that simplifies and reduces the number of user inputs to set a threshold. In other words, the user input could be a single input (e.g., a right click) or an input combination (e.g., a double click) received from at least one input device (e.g., mouse) that triggers the action of setting a threshold for one or more network characteristics. Input combinations, such as hotkeys, keyboard shortcuts, double tapping, and/or double clicking, are well-known in the art.

Method 900 then moves to block 906 to create and activate a threshold for monitoring the network characteristics based on the received user input. Method 900 can automatically construct the monitoring rule and/or policy that includes the threshold by using contextual information to deduce the measured network characteristics, data sizes, time base, and/or network scope, apply the monitoring rule and/or policy to the switching device, and automatically activate the monitoring rule and/or policy. After creating and activating the monitoring rule and/or policy, method 900 continues to block 908 and triggers one or more actions associated with the monitoring rule when the measured data exceeds the threshold. The measured data may represent data displayed on the performance graph. If any of the measured data, such as data received and displayed before the threshold creation, exceeds the established threshold, for example, the data is less than the threshold, then method 900 triggers actions, such as generating one or more visual indications within the monitoring window. In another embodiment, method 900 triggers actions for measured data received after the creation of the threshold and does not trigger actions for measured data received prior to the creation of the threshold. Other non-limiting examples of triggered actions include changing a status icon located on a user interface, decommissioning a port, fencing a port, adds an entry to an internal event log (e.g., RAS log events), generating and transmitting an email, generating and transmitting other notifications, and/or performing other actions to recover or minimize device and/or network failure.

Method 900 then proceeds to block 910 to delete or deactivate the threshold for monitoring the network characteristics. In one embodiment, method 900 automatically deletes or deactivates temporarily created thresholds based on an occurrence of an event, such as closing of a monitoring window, minimizing the monitoring window, and/or expiration of a designated time duration. For the expiration of a designated time duration, once method 900 creates temporary threshold with the threshold input option, method 900 may automatically start a counter that tracks the elapsed time since creating the threshold. Once the elapsed time exceeds the designated time duration (e.g., about ten minutes), the method 900 deletes or deactivates the temporary threshold. Additionally or alternatively, method 900 deletes or deactivates permanent thresholds after receiving manual instructions from the network administrator.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of.

The above description is intended to be illustrative, and not restrictive. For example, the above-described embodiments may be used in combination with each other. Many other embodiments will be apparent to those of skill in the art upon reviewing the above description. The scope of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method comprising:
displaying on a graphical display a window displaying data for one or more network characteristics within a network, wherein the window includes contextual information for the displayed data;
receiving a first user input at a location on the window, wherein the first user input causes a display of one or more options to set a threshold for the one or more network characteristics, wherein a threshold is a setting which triggers a predetermined action when a condition of the threshold is met; and
automatically creating the threshold based on the first user input and the contextual information, wherein the condition of the threshold includes a value, and wherein the condition's value is determined from the location of the first user input on the window.

2. The method of claim 1, wherein the one or more options to set the threshold includes a first option to set a temporary threshold and a second option to set a permanent threshold.

3. The method of claim 2, wherein the temporary threshold remains active as long as the window remains open.

4. The method of claim 2, wherein the second option configures the threshold to a device located in the network, and wherein the contextual information includes information for the device.

5. The method of claim 2, wherein the permanent threshold remains active after the window is closed or minimized.

6. The method of claim 1, further comprising:
receiving a second user input that selects one of the one or more options to set the threshold; and
automatically creating the threshold based on the first user input, the second user input, and the contextual information.

7. The method of claim 1, wherein the predetermined action is generating a visual indication within the window.

8. The method of claim 1, wherein automatically creating the threshold based on the first user input and the contextual information comprises associating the condition's value with a time base parameter to generate a monitoring rule based on the contextual information.

9. A non-transitory program storage device, readable by one or more programmable control devices and comprising instructions stored thereon to cause the one or more programmable control devices to:
display on a graphical display a window displaying data for one or more network characteristics within a network, wherein the window includes contextual information for the displayed data;
receive a first user input at a location on the window, wherein the first user input causes a display of one or more options to set a threshold for the one or more network characteristics, wherein a threshold is a setting which triggers a predetermined action when a condition of the threshold is met; and
automatically create the threshold based on the first user input and the contextual information, wherein the condition of the threshold includes a value, and wherein the condition's value is determined from the location of the first user input on the window.

10. The non-transitory program storage device of claim 9, wherein the one or more options to set the threshold includes a first option to set a temporary threshold and a second option to set a permanent threshold.

11. The non-transitory program storage device of claim 10, wherein the temporary threshold remains active as long as the window remains open.

12. The non-transitory program storage device of claim 9, wherein instructions cause the one or more programmable control devices to:
receive a second user input that selects one of the one or more options to set the threshold; and
automatically create the threshold based on the first user input, the second user input, and the contextual information.

13. The non-transitory program storage device of claim 9, wherein the predetermined action is generating a visual indication within the window.

14. The non-transitory program storage device of claim 13, wherein the instructions to automatically create a threshold based on the single user input and the contextual information comprises instructions that case the one or more programmable control devices to associate the condition's value with a time base parameter to generate a monitoring rule based on the contextual information.

15. A system comprising:
at least one processor; and
storage coupled to the at least processor and storing computer-executable instructions for an application that cause the at least one processor to:
display on a graphical display a window displaying data for one or more network characteristics within a network, wherein the window includes contextual information for the displayed data;
receive a first user input at a location on the window, wherein the first user input causes a display of one or more options to set a threshold for the one or more network characteristics, wherein a threshold is a setting which triggers a predetermined action when a condition of the threshold is met; and
automatically create the threshold based on the first user input and the contextual information, wherein the condition of the threshold includes a value, and wherein the condition's value is determined from the location of the first user input on the window.

16. The system of claim 15, wherein the one or more options to set the threshold includes a first option to set a temporary threshold and a second option to set a permanent threshold.

17. The system of claim 16, wherein the permanent threshold remains active after the window is closed or minimized.

18. The system of claim 15, wherein instructions further cause the at least one processor to:
receive a second user input that selects one of the one or more options to set a threshold; and
automatically create the threshold based on the first user input, the second user input, and the contextual information.

19. The system of claim 15, wherein the predetermined action is generating a visual indication within the window.

20. The system of claim 19, wherein the instructions to automatically create a threshold based on the first user input and the contextual information comprises instructions that case the at least one processor to associate the condition's value with a time base parameter to generate a monitoring rule based on the contextual information.
